(19) United States
(12) Patent Application Publication
(10) Pub. No.: US 2017/0239538 A1
(43) Pub. Date: Aug. 24, 2017

(54) Golfing Performance Assistance Device

(71) Applicant: Dominic Palermo, Atlanta, GA (US)

(72) Inventor: Dominic Palermo, Atlanta, GA (US)

(21) Appl. No.: 15/049,222

(22) Filed: Feb. 22, 2016

(51) Int. Cl. A63B 57/00; G02C 7/10; G02C 5/12; G02C 5/14; G02B 27/01; G02C 11/00

(52) U.S. Cl. CPC A63B 57/00; G02B 27/0172; G02C 11/10; G02C 5/12; G02C 5/146; G02C 7/10; G02B 2027/0178; G02B 2027/014; G02B 2027/0141

(57) ABSTRACT

A golfing performance assistance device for performance assistance through range finding and terrain mapping includes a housing. A power module, a microprocessor, a receiver and a memory storage unit are coupled to and positioned in the housing. The microprocessor is operationally coupled to the power module. The receiver is global positioning system enabled. A range finder, which is laser enabled, is coupled to and positioned in a frame of a pair of glasses. A display that comprises at least one eyepiece of the pair of glasses is coupled to the housing. The receiver, the memory storage unit, the range finder and the display are operationally coupled to the microprocessor. The range finder determines the distance between the user and a visualized target. The range finder, receiver and the memory storage unit are coupled to the microprocessor for determining the distance, map and slope to present on the display.

### BACKGROUND OF THE DISCLOSURE

Field of the Disclosure

The disclosure relates to golfing devices and more particularly pertains to a new golfing device for performance assistance through range finding and terrain mapping.

### SUMMARY OF THE DISCLOSURE

An embodiment of the disclosure meets the needs presented above by generally comprising a housing. A power module, a microprocessor, a receiver and a memory storage unit are coupled to and positioned in the housing. The microprocessor is operationally coupled to the power module. The receiver is global positioning system enabled. A range finder, which is laser enabled, is coupled to and positioned in a frame of a pair of glasses. A display that comprises at least one eyepiece of the pair of glasses is coupled to the housing. The receiver, the memory storage unit, the range finder and the display are operationally coupled to the microprocessor. The range finder determines the distance between the user and a visualized target. The range finder, receiver and the memory storage unit are coupled to the microprocessor for determining the distance, map and slope to present on the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a golfing performance assistance device according to an embodiment of the disclosure.

FIG. 2a is a rear view of an embodiment of the disclosure.

FIG. 2b is a rear view of an embodiment of the disclosure.

FIG. 3 is a side view of an embodiment of the disclosure.

FIG. 4 is a bottom view of an embodiment of the disclosure.

FIG. 5 is a cross-sectional view of an embodiment of the disclosure.

FIG. 6 is a block diagram of an embodiment of the disclosure.

### DESCRIPTION OF THE PREFERRED EMBODIMENT

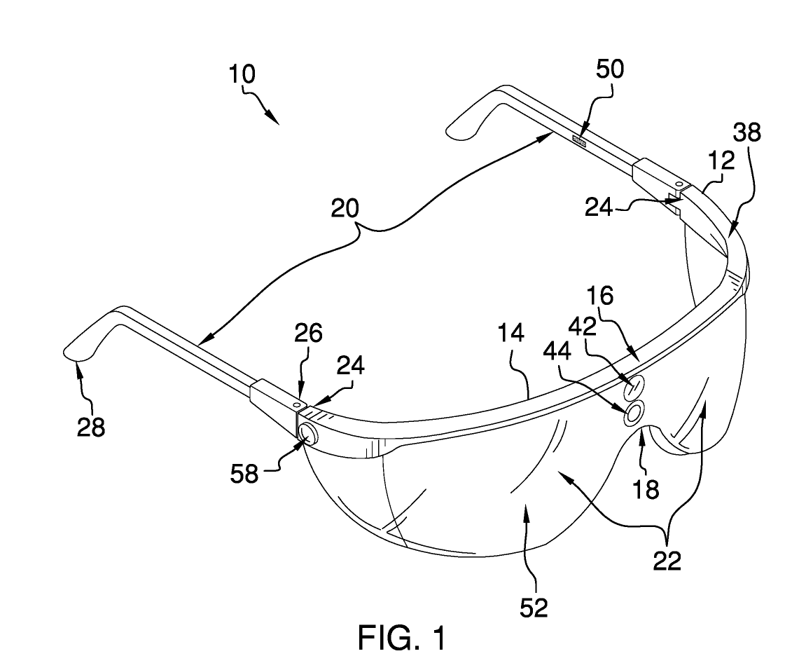

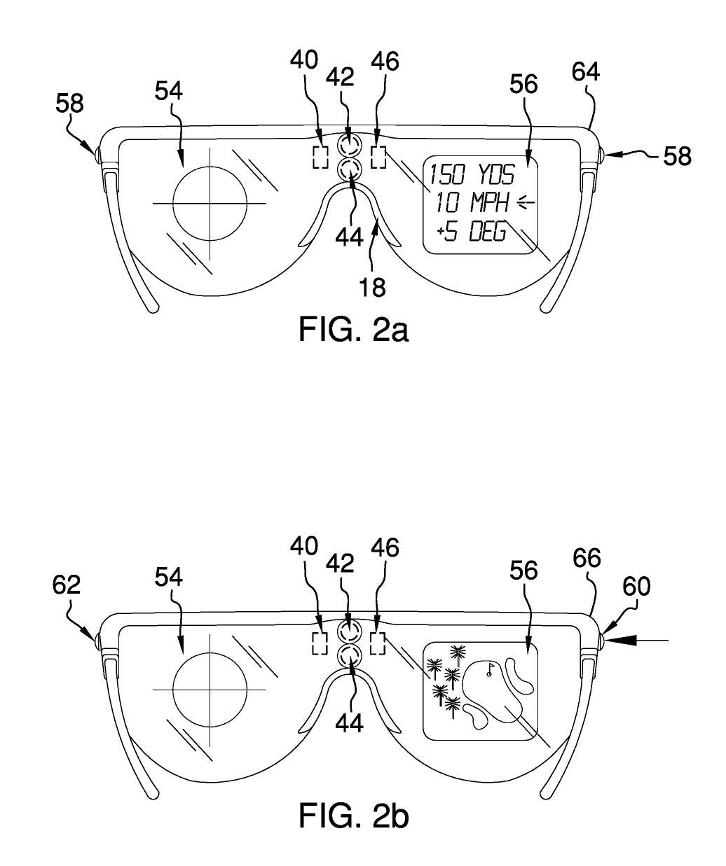

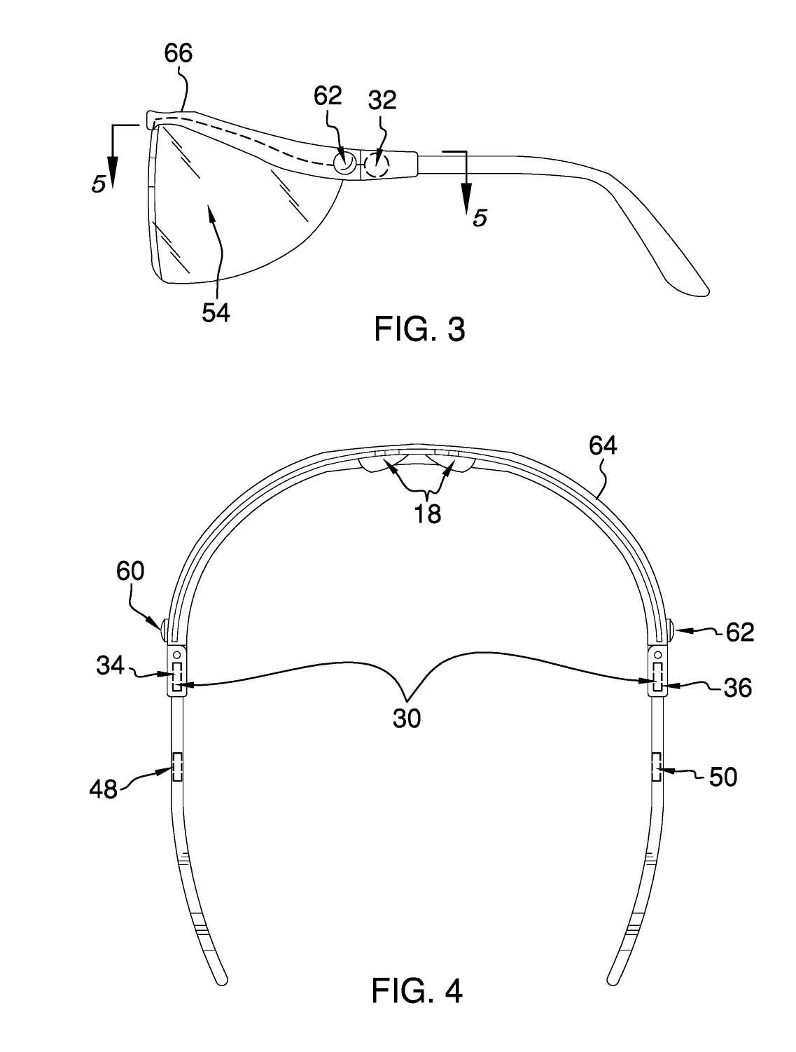

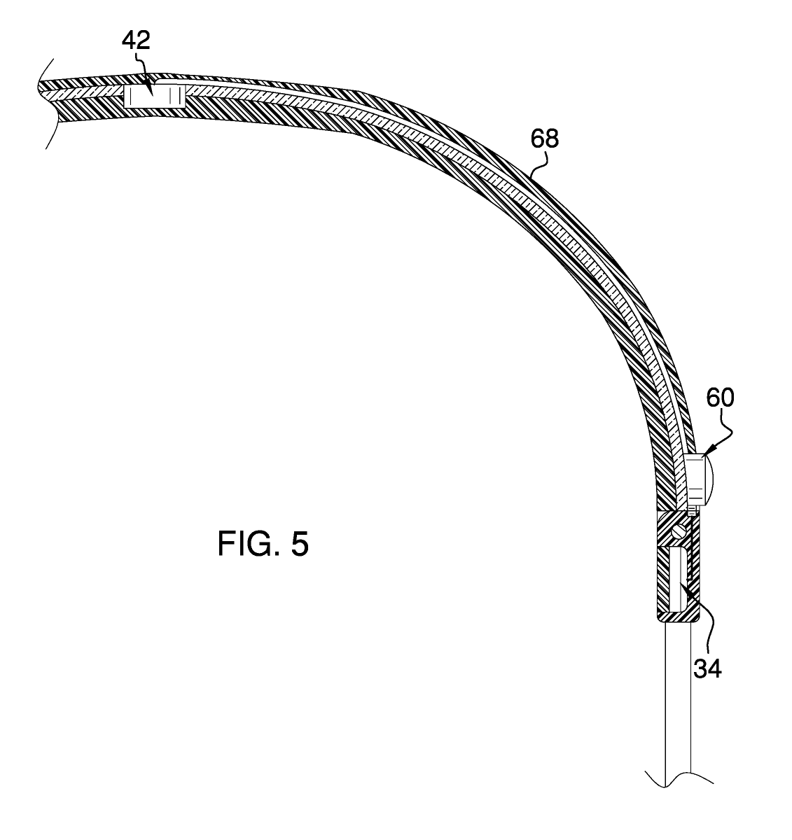

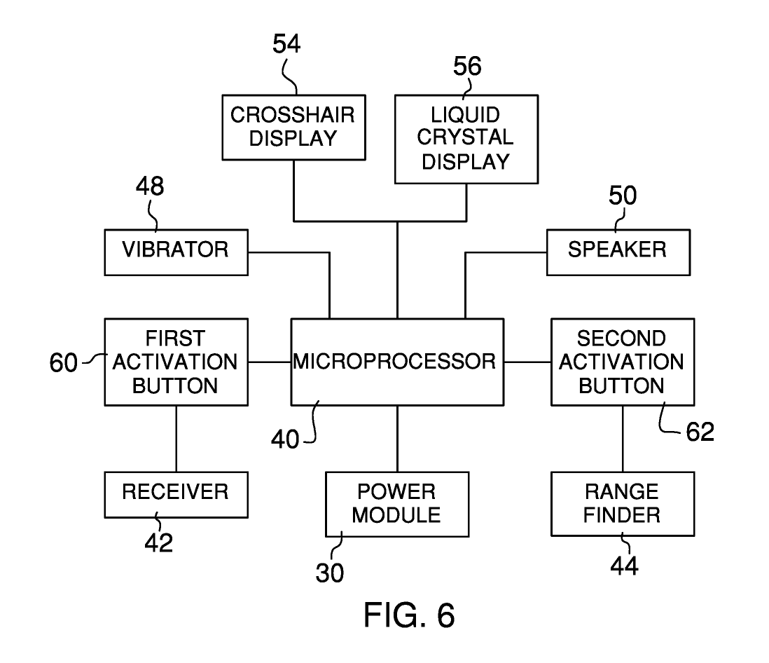

With reference now to the drawings, and in particular to FIGS. 1 through 6 thereof, a new golfing device embodying the principles and concepts of an embodiment of the disclosure and generally designated by the reference numeral 10 will be described.

As best illustrated in FIGS. 1 through 6, the golfing performance assistance device 10 generally comprises a housing 12, which in turn comprises a pair of glasses 14. The pair of glasses 14 comprises a frame 16, a nosepiece 18, a pair of arms 20 and a pair of eyepieces 22. The nosepiece 18 is positioned in the frame 16 equally distant from opposing ends 24 of the frame 16. Each eyepiece 22 is coupled to the frame 16 between the nosepiece 18 and a respective opposing end 24. Each arm 20 has a pivot end 26 and a free end 28. The pivot end 26 is pivotally coupled to a respective opposing end 24 of the frame 16.

A power module 30 is coupled to and positioned in the housing 12. The power module 30 comprises at least one battery 32. Preferably, the power module 30 comprises a first power module 34 and a second power module 36. The first power module 34 and the second power module 36 each comprise at least one battery 32. Preferably the first power module 34 is positioned in a respective arm 20 proximate to a respective pivot end 26, and the second power module 36 is positioned in a respective arm 20 proximate to a respective pivot end 26.

A microprocessor 40 is coupled to and positioned in the housing 12. The microprocessor 40 is operationally coupled to the power module 30. Preferably, the microprocessor 40 is positioned in the frame 16 proximate to a top 38 of the frame 16 and substantially equally distant from the opposing ends 24.

A receiver 42, which is global positioning system enabled, is coupled to and positioned in the housing 12. The receiver 42 is operationally coupled to the microprocessor 40. Preferably, the receiver 42 is positioned in the frame 16 proximate to the top 38 of the frame 16 and substantially equally distant from the opposing ends 24.

A range finder 44, which is laser enabled, is coupled to and positioned in the frame 16. The range finder 44 is operationally coupled to the microprocessor 40. Preferably, the range finder 44 is positioned in the frame 16 proximate to the top 38 of the frame 16 and substantially equally distant from the opposing ends 24.

A memory storage unit 46 is coupled to and positioned in the housing 12. The memory storage unit 46 is operationally coupled to the microprocessor 40. The memory storage unit 46 is configured for storage of three dimensional mapping data. Preferably, the memory storage unit 46 is positioned in the frame 16 proximate to the top 38 of the frame 16 and substantially equally distant from the opposing ends 24.

A vibrator 48 is coupled to and positioned in the housing 12. The vibrator 48 is operationally coupled to the microprocessor 40. The vibrator 48 is configured to provide a perceptible physical notification to the user when the range finder 44 is locked on a target selected by the user. Preferably, the vibrator 48 is positioned in a respective arm 20 of the frame 16 substantially equally distant from the pivot end 26 and the free end 28.

A speaker 50 is coupled to and positioned in the housing 12. The speaker 50 is operationally coupled to the microprocessor 40. The speaker 50 is configured to announce the distance and slope between the user and a target visualized by the range finder 44. Preferably, the speaker 50 is positioned in a respective arm 20 of the frame 16 substantially equally distant from the pivot end 26 and the free end 28.

A display 52 is coupled to the housing 12 comprises at least one eyepiece 22 of the pair of glasses 14. The display 52 is operationally coupled to the microprocessor 40. Preferably, the display 52 comprises a crosshair display 54 and a liquid crystal display 56. The crosshair display 54 is positioned in a respective eyepiece 22 and is operationally coupled to the range finder 44. The liquid crystal display 56 is positioned in a respective eyepiece 22 and is operationally coupled to the receiver 42.

A control panel 58 is operationally coupled to the microprocessor 40, the receiver 42 and the range finder 44. The control panel 58 is positioned in the frame 16 proximate to a respective opposing end 24. Preferably, the control panel 58 comprises a first activation button 60 and a second activation button 62. The first activation button 60 is operationally coupled to the receiver 42 and the microprocessor 40. The first activation button 60 is positioned in the frame 16 proximate to a respective opposing end 24. The first activation button 60 is depressible once by the user to display slope to a visualized target on the liquid crystal display 56 and twice to display a land scape view provided by the memory storage unit 46 on the liquid crystal display 56. The second activation button 62 is operationally coupled to the receiver 42 and the microprocessor 40. The second activation button 62 is positioned in the frame 16 proximate to a respective opposing end 24. The second activation button 62 is depressible by the user to activate the range finder 44 and the crosshair display 54.

The pair of glasses 14 may comprise sunglasses 64. The pair of glasses 14 may comprise prescription glasses 66. The pair of glasses 14 may comprise prescription sunglasses 68. The glasses 14 may also provide conventional UV light protection.

A conventional strap may be coupled to the glasses 14 and used to secure the glasses 14 to prevent slippage or inadvertent loss of the glasses 14.

In use, the range finder 44 is positioned in the frame 16 such that the distance between the user and a visualized target is determinable. The vibrator 48 will notify the user when the target is visualized. The speaker 50 will announce the distance and the display 52 will present the distance in a readable format. The receiver 42 and the memory storage unit 46 are positioned in the housing 12 such that the microprocessor 40 can determine the appropriate three dimensional map and slope to present on the display 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A golfing performance assistance device comprising:
a housing;
a power module, said power module being coupled to and positioned in said housing;
a microprocessor, said microprocessor being coupled to and positioned in said housing, said microprocessor being operationally coupled to said power module;
a receiver, said receiver being global positioning system enabled, said receiver being coupled to and positioned in said housing, said receiver being operationally coupled to said microprocessor;
a range finder, said range finder being laser enabled, said range finder being coupled to and positioned in a frame of a pair of glasses, said range finder being operationally coupled to said microprocessor;
a memory storage unit, said memory storage unit being coupled to and positioned in said housing, said memory storage unit being operationally coupled to said microprocessor, wherein said memory storage unit is configured for storage of three dimensional mapping data;
a display, said display being coupled to said housing, said display comprising at least one eyepiece of said pair of glasses, said display being operationally coupled to said microprocessor;
a pair of glasses, said pair of glasses comprising:
a frame,
a nosepiece, said nosepiece being positioned in said frame equally distant from opposing ends of said frame,
a pair of eyepieces, each said eyepiece being coupled to said frame between said nosepiece and a respective said opposing end, and
a pair of arms, each said arm having a pivot end and a free end, said pivot end being pivotally coupled to a respective said opposing end of said frame; and
wherein said power module comprises a first power module and a second power module, said first power module and said second power module each comprising at least one battery, said first power module being positioned in a respective said arm proximate to a respective said pivot end, said second power module being positioned in a respective said arm proximate to a respective said pivot end.

2. (canceled)

3. The device of claim 1, further including said power module comprising at least one battery.

4. (canceled)

5. The device of claim 1, further including said microprocessor, said receiver, said range finder and said memory storage unit being positioned in said frame proximate to a top of said frame and substantially equally distant from said opposing ends.

6. The device of claim 1, further including a vibrator, said vibrator being coupled to and positioned in said housing, said vibrator being operationally coupled to said microprocessor, wherein said vibrator is configured to provide a perceptible physical notification to the user when said range finder is locked on a target selected by the user.

7. The device of claim 6, further including said vibrator being positioned in a respective arm of said frame substantially equally distant from said pivot end and said free end.

8. The device of claim 1, further including a speaker, said speaker being coupled to and positioned in said housing, said speaker being operationally coupled to said microprocessor, wherein said speaker is configured to announce the distance and slope between the user and a target visualized by said range finder.

9. The device of claim 8, further including said speaker being positioned in a respective arm of said frame substantially equally distant from said pivot end and said free end.

10. The device of claim 1, further including said display comprising:
a crosshair display, said crosshair display being positioned in a respective said eyepiece, said crosshair display being operationally coupled to said range finder; and
a liquid crystal display, said liquid crystal display being positioned in a respective eyepiece, said liquid crystal display being operationally coupled to said receiver.

11. The device of claim 1, further including a control panel, said control panel being operationally coupled to said microprocessor, said receiver and said range finder, said control panel being positioned in said frame proximate to a respective said opposing end.

12. The device of claim 11, further including said control panel comprising:
a first activation button, said first activation button being operationally coupled to said receiver and said microprocessor, said first activation button being positioned in said frame proximate to a respective said opposing end; and
wherein said first activation button is depressible once by the user to display slope to a visualized target on said liquid crystal display and twice to display a land scape view provided by said memory storage unit on said liquid crystal display.

13. The device of claim 11, further including said control panel comprising:
a second activation button, said second activation button being operationally coupled to said receiver and said microprocessor, said second activation button being positioned in said frame proximate to a respective said opposing end; and
wherein said second activation button is depressible by the user to activate said range finder and said crosshair display.

14. The device of claim 1, further including said pair of glasses comprising sunglasses.

15. The device of claim 1, further including said pair of glasses comprising prescription glasses.

16. The device of claim 1, further including said pair of glasses comprising prescription sunglasses.

17. A golfing performance assistance device comprising:
a housing, said housing comprising a pair of glasses;
said pair of glasses comprising:
a frame,
a nosepiece, said nosepiece being positioned in said frame equally distant from opposing ends of said frame,
a pair of eyepieces, each said eyepiece being coupled to said frame between said nosepiece and a respective said opposing end, and
a pair of arms, each said arm having a pivot end and a free end, said pivot end being pivotally coupled to a respective said opposing end of said frame;
a power module, said power module being coupled to and positioned in said housing, said power module comprising at least one battery, said power module comprising a first power module and a second power module, said first power module and said second power module each comprising at least one battery, said first power module being positioned in a respective said arm proximate to a respective said pivot end, said second power module being positioned in a respective said arm proximate to a respective said pivot end;
a microprocessor, said microprocessor being coupled to and positioned in said housing, said microprocessor being operationally coupled to said power module, said microprocessor being positioned in said frame proximate to a top of said frame and substantially equally distant from said opposing ends;
a receiver, said receiver being global positioning system enabled, said receiver being coupled to and positioned in said housing, said receiver being operationally coupled to said microprocessor, said receiver being positioned in said frame proximate to said top of said frame and substantially equally distant from said opposing ends;
a range finder, said range finder being laser enabled, said range finder being coupled to and positioned in said frame, said range finder being operationally coupled to said microprocessor, said range finder being positioned in said frame proximate to said top of said frame and substantially equally distant from said opposing ends;
a memory storage unit, said memory storage unit being coupled to and positioned in said housing, said memory storage unit being operationally coupled to said microprocessor, wherein said memory storage unit is configured for storage of three dimensional mapping data, said memory storage unit being positioned in said frame proximate to said top of said frame and substantially equally distant from said opposing ends;
a vibrator, said vibrator being coupled to and positioned in said housing, said vibrator being operationally coupled to said microprocessor, wherein said vibrator is configured to provide a perceptible physical notification to the user when said range finder is locked on a target selected by the user, said vibrator being positioned in a respective arm of said frame substantially equally distant from said pivot end and said free end;
a speaker, said speaker being coupled to and positioned in said housing, said speaker being operationally coupled to said microprocessor, wherein said speaker is configured to announce the distance and slope between the user and a target visualized by said range finder, said speaker being positioned in a respective arm of said frame substantially equally distant from said pivot end and said free end;
a display, said display being coupled to said housing, said display comprising at least one eyepiece of a pair of glasses, said display being operationally coupled to said microprocessor;
said display comprising:
a crosshair display, said crosshair display being positioned in a respective said eyepiece, said crosshair display being operationally coupled to said range finder, and
a liquid crystal display, said liquid crystal display being positioned in a respective eyepiece, said liquid crystal display being operationally coupled to said receiver;
a control panel, said control panel being operationally coupled to said microprocessor, said receiver and said range finder, said control panel being positioned in said frame proximate to a respective said opposing end;
said control panel comprising:
a first activation button, said first activation button being operationally coupled to said receiver and said microprocessor, said first activation button being positioned in said frame proximate to a respective said opposing end, wherein said first activation button is depressible once by the user to display slope to a visualized target on said liquid crystal display and twice to display a land scape view provided by said memory storage unit on said liquid crystal display,
a second activation button, said second activation button being operationally coupled to said receiver and said microprocessor, said second activation button being positioned in said frame proximate to a respective said opposing end, wherein said second activation button is depressible by the user to activate said range finder and said crosshair display;
said pair of glasses comprising sunglasses;
said pair of glasses comprising prescription glasses;
said pair of glasses comprising prescription sunglasses; and
wherein said range finder is positioned in said frame such that the distance between the user and a visualized target is determinable, and wherein said vibrator will notify the user when the target is visualized and said speaker will announce the distance and said display will present the distance in a readable format, wherein said receiver and said memory storage unit are positioned in said housing such that said microprocessor can determine the appropriate three dimensional map and slope to present on said display.
